(19) United States
(12) Patent Application Publication
(10) Pub. No.: US 2008/0059763 A1
(43) Pub. Date: Mar. 6, 2008

(54) System and method for fine-grain instruction parallelism for increased efficiency of processing compressed multimedia data

(76) Inventor: Lazar Bivolarski, Cupertino, CA (US)

Correspondence Address: HAVERSTOCK & OWENS LLP, 162 N WOLFE ROAD, SUNNYVALE, CA, 94086, US

(21) Appl. No.: 11/897,785

(22) Filed: Aug. 30, 2007

Related U.S. Application Data
(60) Provisional application No. 60/841,888, filed on Sep. 1, 2006.

(51) Int. Cl. G06F 15/76

(52) U.S. Cl. 712/21

(57) ABSTRACT

A method and system of processing compressed multimedia data using fine-grain instruction parallelism is provided. The method of processing multimedia data includes transferring an instruction from each of a plurality of sequencers to associated processing elements within an array of processing elements. The instructions can be processed by the array of processing elements using fine-grain instruction parallelism. A selection mechanism using selection instructions can select the associated processing elements. The plurality of sequencers comprise fine-grain instructions for decoding the compressed multimedia data. A system for multimedia data processing includes a data parallel system which can include an array of processing elements. A plurality of sequencers are coupled to the array of processing elements. A direct memory access component is coupled to the array of processing elements. A diagonal mapping scheme can be used in transferring instructions and data to the processing elements.

### RELATED APPLICATION(S)

This Patent Application claims priority under 35 U.S.C. §119(e) of the co-pending, co-owned U.S. Provisional Patent Application No. 60/841,888, filed Sep. 1, 2006, and entitled “INTEGRAL PARALLEL COMPUTATION” which is also hereby incorporated by reference in its entirety.

This Patent Application is related to U.S. patent application Ser. No. ______, entitled “INTEGRAL PARALLEL MACHINE”, [Attorney Docket No. CONX-00101] filed ______, which is also hereby incorporated by reference in its entirety.

### FIELD OF THE INVENTION

The present invention relates to the field of data processing. More specifically, the present invention relates to multimedia data processing using fine-grain instruction parallelism.

### BACKGROUND OF THE INVENTION

Computing workloads in the emerging world of “high definition” digital multimedia (e.g. HDTV and HD-DVD) more closely resembles workloads associated with scientific computing, or so called supercomputing, rather than general purpose personal computing workloads. Unlike traditional supercomputing applications, which are free to trade performance for super-size or super-cost structures, entertainment supercomputing in the rapidly growing digital consumer electronic industry imposes extreme constraints of both size and cost.

With rapid growth has come rapid change in market requirements and industry standards. The traditional approach of implementing highly specialized integrated circuits (ASICs) is no longer cost effective as the research and development required for each new application specific integrated circuit is less likely to be amortized over the ever shortening product life cycle. At the same time, ASIC designers are able to optimize efficiency and cost through judicious use of parallel processing and parallel data paths. An ASIC designer is free to look for explicit and latent parallelism in every nook and cranny of a specific application or algorithm, and then exploit that in circuits. With the growing need for flexibility, however, an embedded parallel computer is needed that finds the optimum balance between all of the available forms of parallelism, yet remains programmable.

Embedded computation requires more generality/flexibility than that offered by an ASIC, but less generality than that offered by a general purpose processor. Therefore, the instruction set architecture of an embedded computer can be optimized for an application domain, yet remain “general purpose” within that domain.

The current implementations of data parallel computing systems use only one instruction sequencer to send one instruction at a time to an array of processing elements. This results in significantly less than 100% processor utilization, typically closer to the 20%-60% range because many of the processing elements have no data to process or because they have the inappropriate internal state.

### SUMMARY OF THE INVENTION

In accordance with a first aspect of the present invention, a method of processing multimedia data is provided. The method includes transferring an instruction from each of a plurality of sequencers to associated processing elements within an array of processing elements. The instructions can be processed by the array of processing elements using fine-grain instruction parallelism. The plurality of sequencers comprises fine-grain instructions for decoding compressed multimedia data. A selection mechanism coupled to the plurality of sequencers is used in selecting the associated processing elements. The associated processing elements are selected using a selection instruction of the selection mechanism. The selecting of the associated processing elements is prior to transferring of the instructions from the plurality of sequencers to the associated processing elements. The transferring of the instructions from the plurality of sequencers to the associated processing elements uses a diagonal mapping scheme, that loads a data memory of the processing elements in a diagonal order.

The multimedia data is preprocessed prior to the transferring of the instructions from each of the plurality of sequencers to the associated processing elements. In addition, a data dependency map is used for decoding intra-prediction and inter-prediction elements of the multimedia data. Further, a characteristic of the multimedia data is identified. The identified characteristic can include audio, video, or graphics or a combination.

The instructions of the plurality of sequencers are used to process common functional elements of multiple streams of multimedia data. The common functional elements of the multiple streams are processed simultaneously. The multiple streams each are encoded with one or more encoding schemes. The multimedia data includes spatial and temporal dependency. The processing elements of the array of processing elements are individually programmable. Each of the plurality of sequencers comprises a unique instruction set. Each of the plurality of sequencers comprises an independent instruction set.

In accordance with another aspect of the present invention, a system for multimedia data processing is provided. The system includes a data parallel system for performing parallel data computations. The data parallel system can comprise a fine-grain data parallelism architecture for decoding compressed multimedia data. The data parallel system includes an array of processing elements. A plurality of sequencers is coupled to the array of processing elements for providing and sending a plurality of instructions to associated processing elements within the array of processing elements. A direct memory access component is coupled to the array of processing elements for transferring the data to and from a memory. Further, a selection mechanism is coupled to the plurality of sequencers. The plurality of sequencers includes fine-grain instructions for decoding the compressed multimedia data. The selection mechanism is configured to select the associated processing elements.

A diagonal mapping scheme is used in the sending of the plurality of instructions to the associated processing elements. The diagonal mapping scheme is configured to load a data memory of the processing elements in a diagonal order. The instructions of the plurality of sequencers include common functional fine-grain instructions of a decoding algorithm for decoding the multimedia data. The processing elements of the array of processing elements are individually programmable. Each of the plurality of sequencers includes a unique instruction set. Each of the plurality of sequencers includes an independent instruction set.

In accordance with yet another aspect of the current invention, a method of processing multimedia data is provided. The method includes sampling a datastream. The datastream is separated into homogenous subsets of data. The homogenous subsets are processed using multiple selected processing elements for each subset. A plurality of instruction sequencers transfers fine-grain instructions to the selected processing elements for decoding the multimedia data stream. A selection mechanism is used in selecting the processing elements. The datastream is preprocessed prior to the separating of the datastream. A fine-grain selection scheme to select the subsets of data is used in the preprocessing of the datastream.

Other objects and features of the present invention will become apparent from consideration of the following description taken in conjunction with the accompanying drawings.

### BRIEF DESCRIPTION OF THE DRAWINGS

FIG. 1 illustrates a block diagram of an integral parallel machine for processing compressed multimedia data using fine grain parallelism according to an aspect of the present invention.

FIG. 2A illustrates a block diagram of a linear time parallel system.

FIG. 2B illustrates a block diagram of a looped time parallel system.

FIG. 3 illustrates a block diagram of a data parallel system including a fine-grain instruction parallelism architecture according to another aspect of the current invention.

FIG. 4 illustrates a flowchart of a method of processing compressed multimedia data using fine grain parallelism according to still another aspect of the present invention.

### DETAILED DESCRIPTION OF THE PREFERRED EMBODIMENT

The present invention maximizes the use of processing elements (PEs) in an array for data parallel processing. In previous implementations of PEs with one sequencer, occasionally the degree of parallelism was small, and many of the PEs were not used. The present invention employs multiple sequencers to enable more efficient use of the PEs in the array. Each instruction sequencer used to drive the array issues an instruction to be executed only by selected PEs. By utilizing multiple sequencers, two or more streams of instructions can be broadcast into the array and multiple programs are able to be processed simultaneously, one for each instruction sequencer.

An Integral Parallel Machine (IPM) incorporates data parallelism, time parallelism and speculative parallelism but separates or segregates each. In particular, data parallelism and time parallelism are separated with speculative parallelism in each. The mixture of the different kinds of parallelism is useful in cases that require multiple kinds of parallelism for efficient processing.

An example of an application for which the different kinds of parallelism are required but are preferably separated is a sequential function. Some functions are pure sequential functions such as f(h(x)). The important aspect of a pure sequential function is that it is impossible to compute f before computing h since f is reliant on h. For such functions, time parallelism can be used to enhance efficiency which becomes very crucial. By understanding that it is possible to turn a sequential pipe into a parallel processor, a pipeline of sequential machines can be used to compute sequential functions very efficiently.

For example, two machines in sequence are used to compute f(h(x)). The machines include a first machine computing h is coupled to a second machine computing f. A stream of operands, x₁, x₂, . . . xₙ, is processed such that h(x₁) is processed by the first machine while the second machine computing f performs no operation in the first clock cycle. Then, in the second clock cycle, h(x₂) is processed by the first machine, and f(h(x₁)) is processed by the second machine. In the third clock cycle, h(x₃) is processed while f(h(x₂)) is processed. The process continues until f(h(xₙ)) is computed. Thus, aside from a small latency required to fill the pipeline (a latency of two in the above example), the pipeline is able to perform computations in parallel for a sequential function and produce a result in each clock cycle, thereafter.

For a set of sequential machines to work properly as a parallel machine, the set preferably functions without interruption. Therefore, when confronted with a situation such as:

c=c[0]?c+(a+b):c+(a−b),

not only is time parallelism important but speculative parallelism is as well. The code above is interpreted to mean that if a Least Significant Bit (LSB) of c is 1, then set c equal to c+(a+b), but if the LSB of c is 0, then set c equal to c+(a−b). Typically, the value of c is determined first to find out if it is a 0 or 1, and then depending on the value of c, b would either be added to a, or b would be subtracted from a. However, by performing the functions in such an order would cause an interruption in the process as there would be a delay waiting to determine the value of c to determine which branch to take. This would not be an efficient parallel system. If clock cycles are wasted waiting for a result, the system is no longer functioning in parallel at that point. The solution to this problem is referred to as speculative parallelism. Both a+b and a−b are calculated by a machine in the set of machines, and then the value of c is used to select the proper result after they are both computed. Thus, there is no time spent waiting, and the sequence continues to be processed in parallel.

To implement a sequential pipeline to perform computations in parallel, each processing element in a sequential pipeline is able to take data from any of the previous processing elements. Therefore, going back to the example of using c[0] to determine a+b or a−b, in a sequence of processing elements, a first processing element stores the data of c[0]. A second processing element computes c+(a+b). A third processing element computes c+(a−b). A fourth processing element takes the proper value from either the second or third processing element depending on the value of c[0]. Thus, the second and third processing elements are able to utilize the information received from the first processing element to perform their computations. Furthermore, the fourth processing element is able to utilize information from the second and third processing elements to make its computation or selection.

To select previous processing elements, preferably a selector/multiplexer is used, although in some embodiments, other mechanisms are implemented. In an alternative embodiment, a file register is used. Preferably, it is possible to choose from 8 previous processing elements, although fewer or more processing elements are possible.

The following is a description of the components of the IPM. A memory is used to store data and programs and to organize interface buffers between all sub-systems. Preferably, a portion of the memory is on chip, and a portion of it is on external RAM. An input-output system includes general purpose interfaces and, if desired, application specific interfaces. A host is one or more general purpose controllers used to control the interaction with the external world or to run sequential operations that are neither data intensive nor time intensive. A data parallel system is an array of processing elements interconnected by a simple network. A time parallel system with speculative capabilities is a dynamically reconfigurable pipe of processing elements. In each clock cycle, new data is inserted into the pipe of processing elements. In a pipe with n blocks, it is possible to do n computations in parallel. As described above there is an initial latency, but with a large amount of data, the latency is negligible. After the latency period, each clock cycle produces a single result.

The IPM is a “data-centric” design. This is in contrast with most general purpose high-performance sequential machines, which tend to be “program-centric.” The IPM is organized around the memory in order to have maximum flexibility in partitioning the overall computation into tasks performed by different complementary resources.

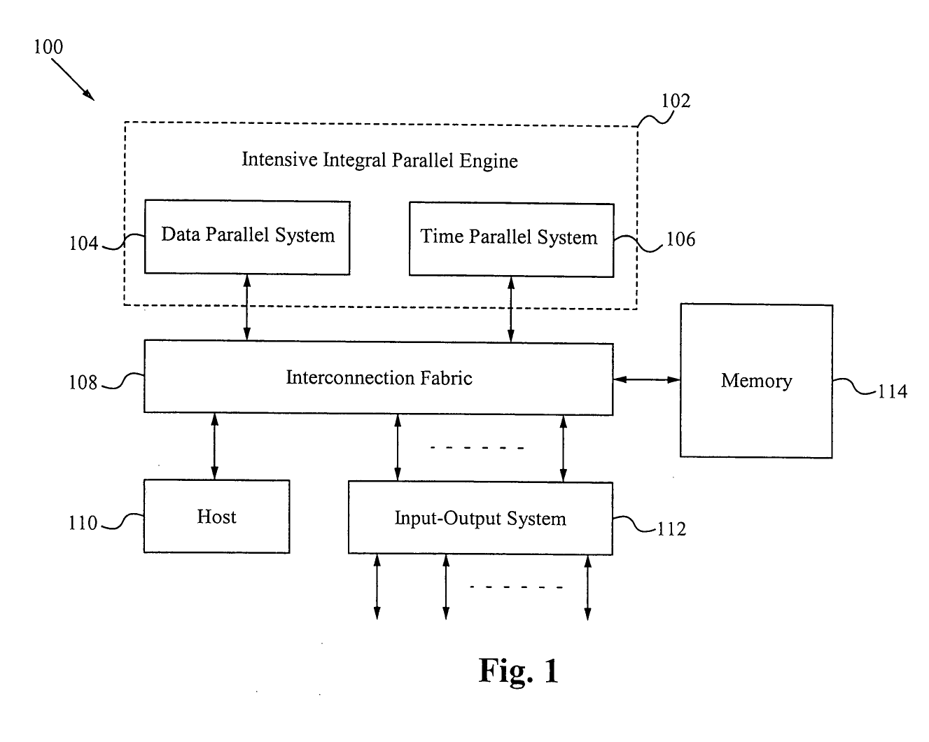

FIG. 1 illustrates a block diagram of an Integral Parallel Machine (IPM) 100. The IPM 100 is a system for multimedia data processing. The IPM 100 includes an intensive integral parallel engine 102, an interconnection fabric 108, a host 110, an Input-Output (I/O) system 112 and a memory 114. The intensive integral parallel engine 102 is the core containing the parallel computational resources. The intensive integral parallel engine 102 implements the three forms of parallelism (data, time and speculative) segregated in two subsystems—a data parallel system 104 and a time parallel system 106.

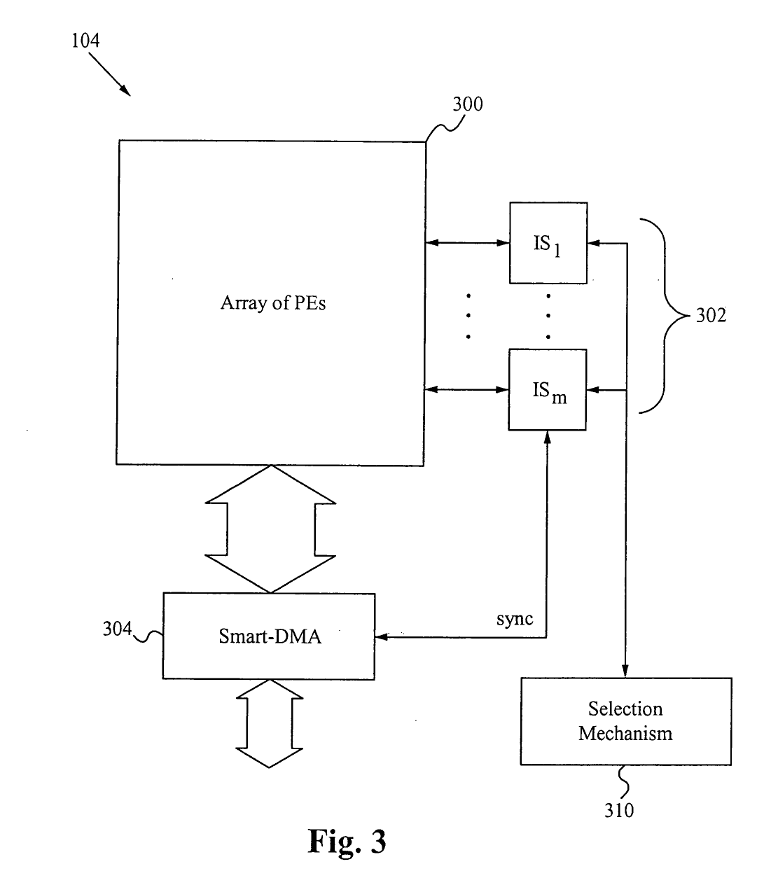

The data parallel system 104 is an array of processing elements interconnected by a simple network. The data parallel system 104 issues, in each clock cycle, multiple instructions. The instructions are broadcast into the array for performing a function as will be described herein below in reference to FIG. 3. Related data parallel systems are described further in U.S. Pat. No. 7,107,478, entitled DATA PROCESSING SYSTEM HAVING A CARTESIAN CONTROLLER, and U.S. Patent Publ. No. 2004/0123071, entitled CELLULAR ENGINE FOR A DATA PROCESSING SYSTEM, which are hereby incorporated by reference in their entirety.

The time parallel system 106 is a dynamically reconfigurable pipe of processing elements. Each processing element in the data parallel system 104 and the time parallel system 106 is individually programmable.

The memory 114 is used to store data and programs and to organize interface buffers between all of the sub-systems. The I/O system 112 includes general purpose interfaces and, if desired, application specific interfaces. The host 110 is one or more general purpose controllers used to control the interaction with the external world or to run sequential operations that are neither data intensive nor time intensive.

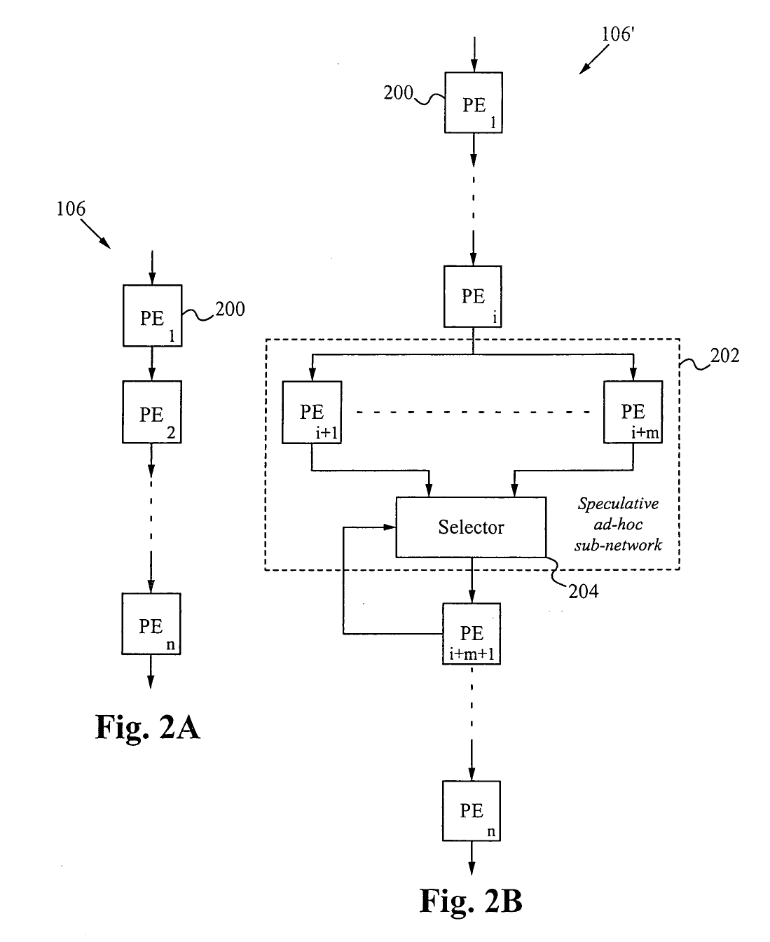

FIG. 2A illustrates a block diagram of a linear time parallel system 106. The linear time parallel system 106 is a line of processing elements 200. In each clock cycle, new data is inserted. Since there are n blocks, it is possible to do n computations in parallel. As described above, there is an initial latency, but typically the latency is negligible. After the latency period, each clock cycle produces a single result. The time parallel system 106 is a dynamically configurable system. Thus, the linear pipe can be reconfigured at the clock cycle level in order to provide “cross configuration” as is shown in FIG. 2B.

As described above, each processing element 200 is able to be configured to perform a specified function. Information, such as a stream of data, enters the time parallel system 106 at the first processing element, PE₁, and is processed in a first clock cycle. In a second clock cycle, the result of PE₁, is sent to PE₂, and PE₂ performs a function on the result while PE₁, receives new data and performs a function on the new data. The process continues until the data is processed by each processing element. Final results are obtained after the data is processed by PEₙ.

FIG. 2B illustrates a block diagram of a looped time parallel system 106′. The looped time parallel system 106′ is similar to the linear time parallel system 106 with a speculative sub-network 202. To efficiently enable more complex processing of data including computing branches such as c=c[0] ? c+(a+b): c+(a−b), the speculative sub-network 202 is used. A selection component 204 such as a selector, multiplexor or file register is used to provide speculative parallelism. The selection component 204 allows a processing element 200 to select input data from a previous processing element that is included in the speculative sub-network 202.

FIG. 3 illustrates a block diagram of a data parallel system 104. The data parallel system 104 comprises a fine-grain instruction parallelism architecture for decoding compressed multimedia data. Fine-grain parallelism comprises processes typically small ranging from a few to a few hundred instructions. The data parallel system 104 includes an array of processing elements 300, a plurality of instruction sequencers 302 coupled to the array of processing elements 300, a Smart-DMA 304 coupled to the array of processing elements 300, and a selection mechanism 310 coupled to the plurality of instruction sequencers 302. The processing elements 300 in the array each execute an instruction broadcasted by the plurality of instruction sequencers 302. The processing elements of the array of processing elements 300 can be individually programmable. The instruction sequencers 302 each generate an instruction each clock cycle. The instruction sequencers 302 provide and send the generated instruction to associated processing elements within the array 300. The plurality of sequencers 302 can comprise fine-grain instructions for decoding the compressed multimedia data. Each of the plurality of sequencers 302 can comprise a unique and an independent instruction set. The instruction sequencers 302 also interact with the Smart-DMA 304. The Smart-DMA 304 is an I/O machine used to transfer data between the array of processing elements 300 and the rest of the system. Specifically, the Smart-DMA 304 transfers the data to and from the memory 114 (FIG. 1). The selection mechanism 310 is configured to select the associated processing elements of the array of processing elements 300. The associated processing elements can be selected using a selection instruction of the selection mechanism 310.

Within the data parallel system several design elements are preferred. Strong data locality of algorithms allows processing elements to be coupled in a compact linear array with nearest neighbor connections. The number of 16-bit processing elements is preferably between 256 and 1024. Each processing element contains a 16-bit ALU, an 8-word register file, a 256-word data memory and a boolean machine with an associated 8-bit state register. Since cycle operations are ADD and SUBTRACT on 16-bit integers, a small number of additional single-clock instructions support efficient (multi-cycle) multiplication. The I/O is a 2-D network of shift registers with one register per processing element for performing a SHIFT function. Two or more independent (stack-based) instruction sequencers including one or more 32-bit instruction sequencers that sequence arithmetic and logic instructions into the array of processing elements and a 32/128-bit stack-based I/O controller (or “Smart-DMA”) are used to transfer data between an I/O plan and the rest of the system which results in a Single Instruction Multiple Data (SIMD)-like machine for one instruction sequencer or a Multiple Instruction Multiple Data (MIMD) of SIMD machine for more than one instruction register. A Smart-DMA and the instruction sequencer communicate with each other using interrupts. Data exchange between the array of the processing elements and the I/O is executed in one clock cycle and is synchronized using a sequence of interrupts specific to each kind of transfer. An instruction sequencer instruction is conditionally executed in each processing element depending on a boolean test of the appropriate bit in the state register.

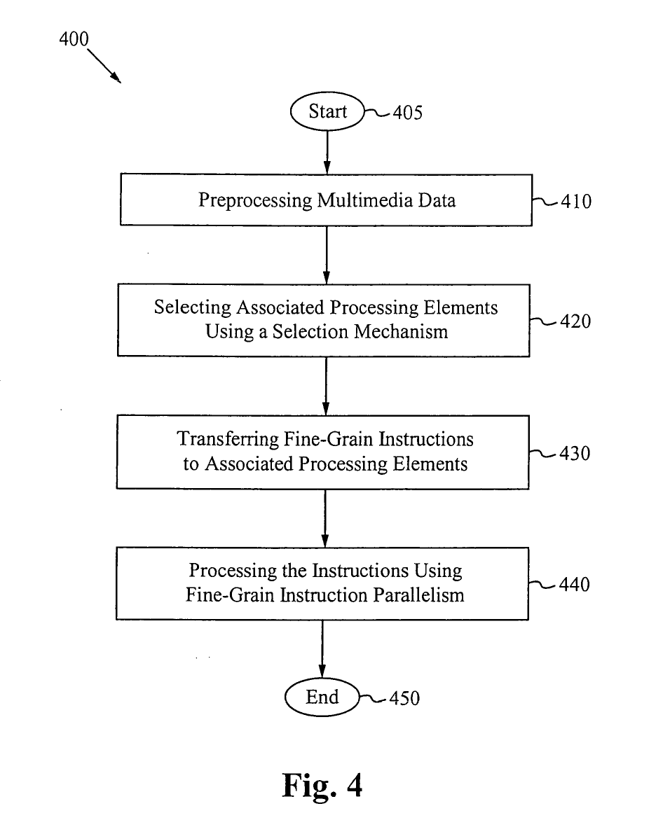

FIG. 4 illustrates a flowchart of a method of processing multimedia data. The method starts at the step 405. In the step 410, the multimedia data is pre-processed. The data is preferably a large amount of sequential data such as a compressed multimedia data stream. In the step 420, the selection mechanism 310 selects associated processing elements within the array of processing element 300. In the step 430, an instruction from each of the plurality of sequencers is transferred to associated processing elements within the array of processing elements 300. Each processing element also receives data decoded from the multimedia data stream. Therefore, n processing elements process a function each clock cycle. The transferring or sending of the instructions from the plurality of sequencers 302 to the associated processing elements uses a diagonal mapping scheme. This diagonal mapping scheme loads a data memory of the processing elements in a diagonal order. Loading the data memory of the processing elements in a diagonal order provides a saving in data memory resources and increases efficiency of data transferring data and instructions to the processing elements.

In the step 440, the instructions are processed by the array of processing elements 300 using fine-grain instruction parallelism. The plurality of sequencers 302 comprise fine-grain instructions for decoding the compressed multimedia data. The instructions of the plurality of sequencers 302 are used to process common functional elements of multiple streams of multimedia data. For example, two streams of multimedia data can be encoded in a different scheme or format, however both of the formats can include video segments in addition to audio segments. An instruction from a sequencer ISm can be transferred to multiple associated processing elements so that the video or the audio segments of the two multimedia data streams are processed simultaneously.

The multimedia data can include spatial and temporal dependencies. A data dependency map can be used for decoding these dependencies. For example the data dependency map can be used for decoding intra-prediction and inter-prediction elements of the multimedia data. The decoding of the multimedia data can include identifying a characteristic of the multimedia data. The characteristic of the multimedia data can include audio, video or graphics or a combination. The method of decoding the multimedia data can include sampling the multimedia data prior to preprocessing the multimedia data. The different characteristic or subset of the multimedia data can be separated and grouped after the preprocessing step 410. Further, the preprocessing of the datastream can use a fine-grain selection scheme to select the subsets of data.

In operation, the present invention is able to be used independently or as an accelerator for a standard computing device. By separating data parallelism and time parallelism, processing data with certain conditions is improved. Specifically, large quantities of data such as video processing benefit from the present invention.

Although single pipelines have been illustrated and described above, multiple pipelines are possible. For multiple bitwise data, multiple stacks of these columns or pipelines of processing elements are used. For example, for 16 bitwise data, 16 columns of processing elements are used.

Additionally, although it is described that each processing element produces a result in one clock cycle, it is possible for each processing element to produce a result in any number of clock cycles such as 4 or 8.

There are many uses for the present invention, in particular where large amounts of data is processed. The present invention is very efficient when processing long streams of data such as in graphics and video processing, for example HDTV and HD-DVD.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of processing multimedia data comprising:
a. transferring an instruction from each of a plurality of sequencers to associated processing elements within an array of processing elements; and
b. processing the instructions by the array of processing elements using fine-grain instruction parallelism,
wherein the plurality of sequencers comprise fine-grain instructions for decoding compressed multimedia data.

2. The method of claim 1, wherein a selection mechanism coupled to the plurality of sequencers is used in selecting the associated processing elements.

3. The method of claim 2, wherein the associated processing elements are selected using a selection instruction of the selection mechanism.

4. The method of claim 2, wherein the selecting of the associated processing elements is prior to transferring of the instructions from the plurality of sequencers to the associated processing elements.

5. The method of claim 1, wherein the transferring of the instructions from the plurality of sequencers to the associated processing elements uses a diagonal mapping scheme.

6. The method of claim 5, wherein the diagonal mapping scheme loads a data memory of the processing elements in a diagonal order.

7. The method of claim 1, further comprising preprocessing the multimedia data prior to the transferring of the instructions from each of the plurality of sequencers to the associated processing elements.

8. The method of claim 1, further comprising using a data dependency map for decoding intra-prediction and inter-prediction elements of the multimedia data.

9. The method of claim 1, further comprising identifying a characteristic of the multimedia data.

10. The method of claim 9, wherein the characteristic of the multimedia data comprises audio, video, or graphics or a combination.

11. The method of claim 1, wherein the instructions of the plurality of sequencers are used to process common functional elements of multiple streams of multimedia data.

12. The method of claim 11, wherein the common functional elements of the multiple streams are processed simultaneously.

13. The method of claim 11, wherein the multiple streams each are encoded with one or more encoding schemes.

14. The method of claim 1, wherein the multimedia data includes spatial and temporal dependency.

15. The method of claim 1, wherein the processing elements of the array of processing elements are individually programmable.

16. The method of claim 1, wherein each of the plurality of sequencers comprises a unique instruction set.

17. The method of claim 1, wherein each of the plurality of sequencers comprises an independent instruction set.

18. A system for multimedia data processing comprising:
a data parallel system for performing parallel data computations,
wherein the data parallel system comprises a fine-grain data parallelism architecture for decoding compressed multimedia data.

19. The system of claim 18, wherein the data parallel system further comprises:
a. an array of processing elements;
b. a plurality of sequencers coupled to the array of processing elements for providing and sending a plurality of instructions to associated processing elements within the array of processing elements;
c. a direct memory access component coupled to the array of processing elements for transferring the data to and from a memory; and
d. a selection mechanism coupled to the plurality of sequencers,
wherein the plurality of sequencers comprise fine-grain instructions for decoding the compressed multimedia data, wherein the selection mechanism is configured to select the associated processing elements.

20. The system of claim 19, wherein the sending of the plurality of instructions to the associated processing elements uses a diagonal mapping scheme.

21. The system of claim 20, wherein the diagonal mapping scheme is configured to load a data memory of the processing elements in a diagonal order.

22. The system of claim 19, wherein the instructions of the plurality of sequencers comprise common functional fine-grain instructions of a decoding algorithm for decoding the multimedia data.

23. The system of claim 19, wherein the processing elements of the array of processing elements are individually programmable.

24. The system of claim 19, wherein each of the plurality of sequencers comprises a unique instruction set.

25. The system of claim 19, wherein each of the plurality of sequencers comprises an independent instruction set.

26. A method of processing multimedia data comprising:
sampling a datastream;
separating the datastream into homogenous subsets of data; and
processing the homogenous subsets using multiple selected processing elements for each subset,
wherein a plurality of instruction sequencers transfer fine-grain instructions to the selected processing elements for decoding the multimedia data stream, wherein a selection mechanism is used in selecting the processing elements.

27. The method of claim 26, further comprising preprocessing the datastream prior to the separating of the datastream.

28. The method of claim 26, wherein the preprocessing of the datastream comprises using a fine-grain selection scheme to select the subsets of data.
